(19) United States
(12) Patent Application Publication
(10) Pub. No.: US 2018/0254010 A1
(43) Pub. Date: Sep. 6, 2018

(54) DISPLAY APPARATUS, METHOD FOR CONTROLLING THE SAME, PROGRAM, AND STORAGE MEDIUM

(71) Applicant: CANON KABUSHIKI KAISHA, Tokyo (JP)

(72) Inventors: Kazuya Kitada, Machida-shi (JP); Takehito Fukushima, Fuchu-shi (JP)

(21) Appl. No.: 15/754,561

(22) PCT Filed: Jul. 25, 2016
(86) PCT No.: PCT/JP2016/003447

§ 371 Date: Feb. 22, 2018

(30) Foreign Application Priority Data
Aug. 31, 2015 (JP) 2015-170595

(51) Int. Cl. G09G 3/36

(52) U.S. Cl. CPC G09G 3/3607; G09G 2340/0435

(57) ABSTRACT

A display apparatus according to the present invention includes a display unit configured to display an image based on a display image, a gradation conversion unit configured to generate the display image by converting gradation values of an input image using reference correction information in a case where a frame rate of the input image is a first frame rate and generate the display image by converting the gradation values of the input image using the reference correction information and correction coefficient information in a case where the frame rate of the input image is a second frame rate which is different from the first frame rate, and a display controller configured to control the display unit so that the image based on the display image is displayed in a driving frequency corresponding to the frame rate of the input image.

### TECHNICAL FIELD

The present invention relates to a display apparatus which is controllable in a plurality of driving frequencies, a method for controlling the display apparatus, a program, and a storage medium.

### BACKGROUND ART

Display apparatuses capable of displaying an image by controlling luminance or chromaticity of a plurality of pixels of an input image have been used. Such a display apparatus controls the plurality of pixels in a driving frequency corresponding to a frame rate of the input image.

PTL1 discloses a technique of suppressing a change of a gradation characteristic caused by a change of a driving frequency by disposing a driving circuit which suppresses a change of a leakage current caused by a change of a driving frequency in a display apparatus which displays an image by applying voltages to a plurality of pixels.

### CITATION LIST

### Patent Literature

PTL 1: Japanese Patent Laid-Open No. 2011-170133

### SUMMARY OF INVENTION

### Solution to Problem

According to an embodiment of the present invention, display apparatus includes a display unit configured to display an image based on a display image, a conversion unit configured to generate the display image by converting gradation values of an input image using reference correction information in a case where a frame rate of the input image is a first frame rate and generate the display image by converting the gradation values of the input image using the reference correction information and correction coefficient information in a case where the frame rate of the input image is a second frame rate which is different from the first frame rate, and a controller configured to control the display unit so that the image based on the display image is displayed in a driving frequency corresponding to the frame rate of the input image.

According to another embodiment of the present invention, a display apparatus includes a display unit configured to display an image based on a display image, a determination unit configured to determine a driving frequency of the display unit; a conversion unit configured to generate the display image by converting gradation values of an input image using reference correction information in a case where the driving frequency is a first frequency and generate the display image by converting gradation values of the input image using the reference correction information and correction coefficient information in a case where the driving frequency is a second frequency which is different from the first frequency, and a controller configured to control the display unit so that the image based on the display image is displayed in the driving frequency.

According to still another embodiment of the present invention, a method for controlling a display apparatus including a display unit which displays an image based on a display image, includes generating the display image by converting gradation values of an input image using reference correction information in a case where a frame rate of the input image is a first frame rate and generating the display image by converting the gradation values of the input image using the reference correction information and correction coefficient information in a case where the frame rate of the input image is a second frame rate which is different from the first frame rate, and controlling the display unit so that the image based on the display image is displayed in a driving frequency corresponding to the frame rate of the input image.

According to a further embodiment of the present invention, a method for controlling a display apparatus including a display unit which displays an image based on a display image, includes determining a driving frequency of the display unit, generating the display image by converting gradation values of an input image using reference correction information in a case where the driving frequency is a first frequency and generating the display image by converting the gradation values of the input image using the reference correction information and correction coefficient information in a case where the driving frequency is a second frequency which is different from the first frequency, and controlling the display unit so that an image based on the display image is displayed in the driving frequency.

Further features of the present invention will become apparent from the following description of exemplary embodiments with reference to the attached drawings.

### BRIEF DESCRIPTION OF DRAWINGS

FIG. 1 is a diagram illustrating a configuration of a display apparatus according to a first embodiment.

FIG. 2 is a block diagram illustrating functional blocks of the display apparatus according to the first embodiment.

FIG. 3 is a graph schematically illustrating a transmittance of a liquid crystal element of a display unit relative to a gradation value in a range from 400 to 460 represented every 10 bits.

FIG. 4A is a diagram schematically illustrating correction information according to the first embodiment.

FIG. 4B is a diagram schematically illustrating correction information according to the first embodiment.

FIG. 5 is a flowchart of a display flow of the display apparatus according to the first embodiment.

FIG. 6 is a diagram illustrating correction information in a driving frequency of 50 Hz.

FIG. 7 is a block diagram illustrating functional blocks of a display apparatus according to a second embodiment.

FIG. 8A is a diagram illustrating reference correction information stored in a memory.

FIG. 8B is a diagram illustrating correction coefficient information stored in the storage unit.

FIG. 9A is a diagram illustrating correction information (reference correction information) in a driving frequency of 60 Hz.

FIG. 9B is a diagram illustrating correction coefficient information in a driving frequency of 48 Hz.

FIG. 10 is a flowchart illustrating a flow of calibration according to the second embodiment.

### DESCRIPTION OF EMBODIMENTS

Hereinafter, embodiments of the present invention will be described with reference to the accompanying drawings. Note that a technical scope of the present invention is defined by claims and is not limited to the embodiments described below. Furthermore, it is not necessarily the case that all combinations of characteristics described in the embodiments are required for the present invention. Content of this specification and the drawings is merely an example and does not limit the present invention. Various modifications (including organic combinations of the embodiments) may be made based on the meaning of the present invention and are not excepted from the scope of the present invention. Specifically, configurations of combinations of the embodiments and the modifications may be all included in the present invention.

### First Embodiment

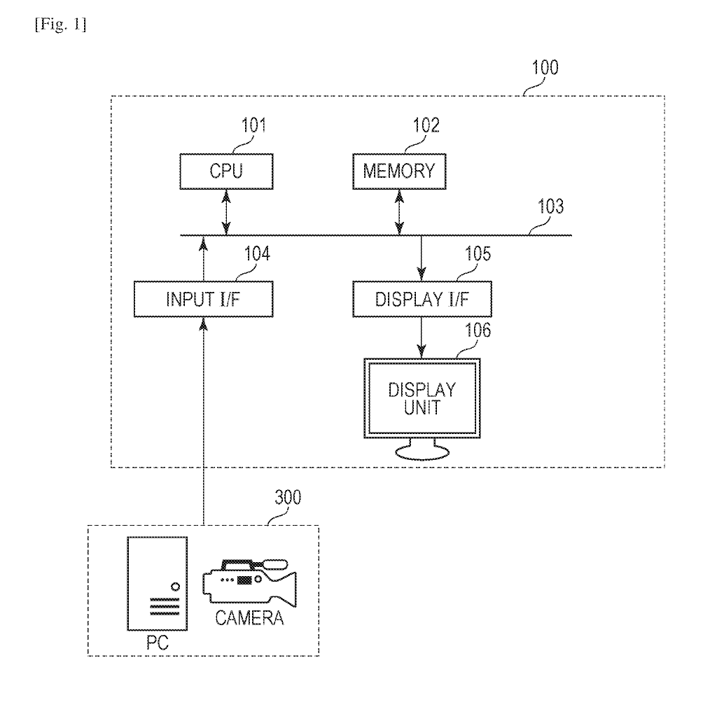

FIG. 1 is a diagram illustrating a configuration of a display apparatus 100 according to a first embodiment. The display apparatus 100 includes a processor 101, a memory 102, a bus line 103, an input interface (I/F) 104, a display interface 105, and a display unit 106.

The processor 101 is a processing unit which controls operation of the display apparatus 100 through the bus line 1103 in accordance with a program read from the memory 102. Any types of processor, such as a central processing unit (CPU) or a micro processing unit (MPU), may be used as the processor 101.

The memory 102 which is a nonvolatile storage medium stores programs to be used by the processor 101 to control the display apparatus 100, correction information to be used to correct gradation values of an input image in accordance with a driving frequency of the display unit 106, and the like. The memory 102 stores correction information corresponding to a plurality of driving frequencies in which the display unit 106 may be driven. The bus line 103 is a common line which connects the processor 101, the memory 102, the input interface 104, and the display interface 105 to one another.

The input interface (I/F) 104 is an input terminal to be connected to an image output apparatus 300 installed outside the display apparatus 100. The input interface 104 is a digital visual interface (DVI), an HDMI (registered trademark), or the like, and a plurality of types of input interfaces 104 may be provided. The input interface 104 connected to the image output apparatus 300 obtains an input image output from the image output apparatus 300.

The image output apparatus 300 is a device, such as an imaging apparatus including a camera or a personal computer (PC), which is capable of outputting an image. The display apparatus 100 may obtain an input image from a recording medium, such as a hard disk, incorporated therein.

The display interface (I/F) 105 converts a display image generated by the CPU based on the input image and the driving frequency into signals which may be processed by the display unit 106 and outputs the signals to the display unit 106.

The display unit 106 is driven in a driving frequency output from a display controller 116 as described below and displays an image based on the display image. In the first embodiment, the display unit 106 is a liquid crystal display. The liquid crystal display includes a liquid crystal panel and an illuminating device (a backlight) which emits light to the liquid crystal panel.

Each of pixels included in the liquid crystal panel includes at least one of a liquid crystal element capable of controlling a transmittance of red (R) light, a liquid crystal element capable of controlling a transmittance of green (G) light, and a liquid crystal element capable of controlling a transmittance of blue (B) light. The liquid crystal panel of the display unit 106 applies voltages corresponding to gradation values of R, G, and B of each of the pixels of the display image on the liquid crystal elements in accordance with signals supplied from the display interface 105 so as to individually control the transmittances of the plurality of liquid crystal elements. A portion of light emitted to the liquid crystal panel from the backlight is transmitted through the liquid crystal panel and an image is displayed on a screen of the liquid crystal panel.

Note that the display unit 106 is not limited to a display apparatus employing a transmission-type display panel, such as a liquid crystal display. The display unit 06 may be a spontaneous-emission-type display apparatus, such as a display using an organic light-emitting diode (OLED) as the elements. Alternatively, the display unit 106 may be a projector which projects and displays a display image on a screen or the like.

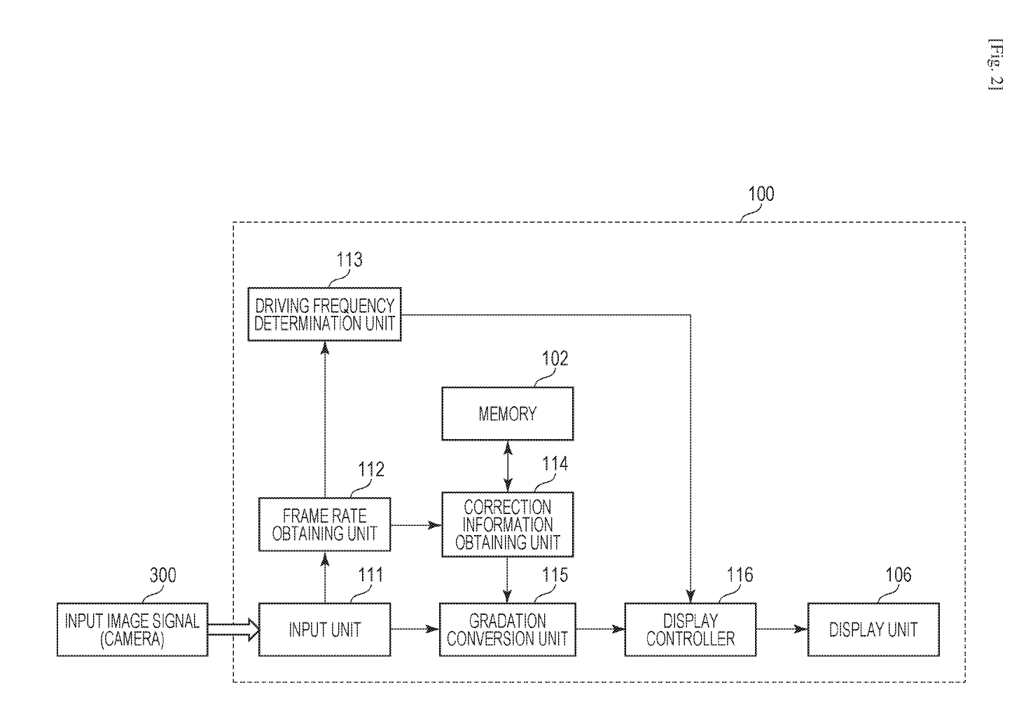

FIG. 2 is a block diagram illustrating functional blocks of the display apparatus 100 according to the first embodiment. The display apparatus 100 includes an input unit 111, a frame rate obtaining unit 112, a driving frequency determination unit 113, a correction information obtaining unit 114, a gradation conversion unit 115, a display controller 116, and the display unit 106. Processes performed by the functional blocks are executed by the processor 101 in accordance with programs read from the memory 102.

The input 111 obtains an input image from the image output apparatus 300. The input unit 111 outputs the input image to the frame rate obtaining unit 112 and the gradation conversion unit 115.

The frame rate obtaining unit 112 obtains a frame rate from the input image. In the first embodiment, the frame rate obtaining unit 112 obtains a frame rate from a format of the input image. Note that the method for obtaining a frame rate from an input image employed in the frame rate obtaining unit 112 is not limited to the method described above. The frame rate obtaining unit 112 may obtain the frame rate of the input image by obtaining additional information indicating the frame rate added to the input image. Alternatively, the frame rate obtaining unit 112 may obtain the frame rate of the input image by analyzing a cycle of the input image. The frame rate obtaining unit 112 outputs the frame rate of the input image to the driving frequency determination unit 113 and the correction information obtaining unit 114.

The driving frequency determination unit 113 determines the obtained frame rate of the input image as a driving frequency of the display unit 106. The determined driving frequency is output to the display controller 116.

The correction information obtaining unit 114 obtains correction information corresponding to the obtained frame rate of the input image and outputs the obtained correction information to the gradation conversion unit 115. Since the driving frequency determination unit 113 determines the frame rate of the input image as the driving frequency of the display unit 106, the correction information corresponding to the obtained frame rate of the input image is seen to be correction information corresponding to the driving frequency of the display unit 106.

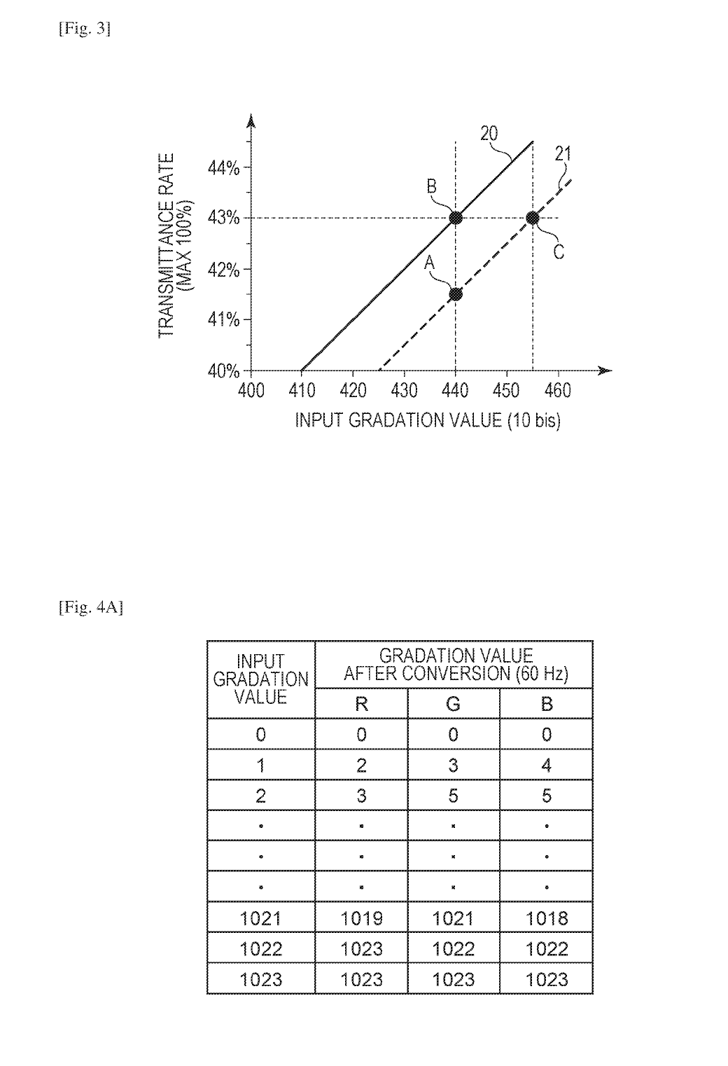

Hereinafter, a gradation characteristic and the correction information will be described. FIG. 3 is a graph schematically illustrating a transmittance rate of a liquid crystal element of the display unit 106 relative to a gradation value in a range from 400 to 460 represented every 10 bits. In FIG. 3, an axis of abscissae denotes an input gradation value represented every 10 bits. In FIG. 3, an axis of ordinates denotes a transmittance rate of the liquid crystal element of the display unit 106 relative to the gradation value input to the display unit 106 in a case where a maximum value of the transmittance of the liquid crystal element of the display unit 106 is determined as 100%. The transmittance rate corresponds to display luminance of display in the display unit 106. The relationship between the gradation value and the display luminance is referred to as a “gradation characteristic”. Note that, if the display unit 106 is a spontaneous-emission-type display apparatus, a light emission amount of the element corresponding to the gradation value input to the display unit 106 is determined as a gradation characteristic.

A straight line 20 of FIG. 3 denotes a gradation characteristic desired by a designer, a manufacturer, or a user to be represented by the display apparatus 100 in the first embodiment. In the first embodiment, a desired gradation characteristic and the gradation value has a liner relationship. The desired gradation characteristic may be arbitrarily set by the designer, the manufacturer, or the user, and instead of the gradation characteristic having linearity as represented by the straight line 20 of FIG. 3, a gradation characteristic which is proportional to 2.2-th power of the gradation value (γ2.2) may be set.

A dotted line 21 in FIG. 3 indicates a characteristic of the display unit 106 in a case where the liquid crystal panel is driven by a driving frequency of 60 Hz. This gradation characteristic may be obtained by calibration performed before shipping in a factory where the display apparatus 100 is fabricated, for example. In the range of the gradation value from 400 to 460, the gradation characteristic by the driving frequency of 60 Hz, has a transmittance lower than that of the desired gradation characteristic.

According to the gradation characteristic in the driving frequency of 60 Hz denoted by the dotted line 21, in a case where the display unit 106 is driven in the driving frequency of 60 Hz by inputting an input gradation value 440, a transmittance rate of the display unit 106 is 41.5% (a point A). To display an image having the desired gradation characteristic, a transmittance rate of 43.0% is required for the gradation value 440 as represented by a point B. To obtain the transmittance rate of 43.0% when the display unit 106 is driven in the driving frequency of 60 Hz, a gradation value of 455 is required (a point C).

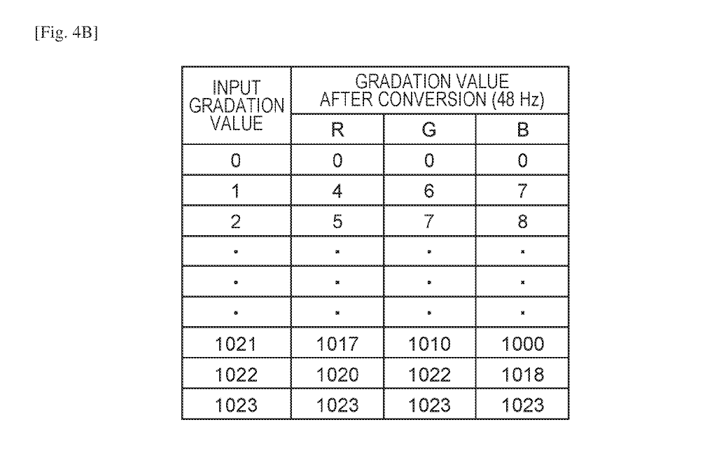

Accordingly, to display an image in the desired gradation characteristic in the display unit 106 driven by the driving frequency of 60 Hz, the gradation value of 440 is required to be converted into the gradation value of 455 to be input to the display unit 106. The correction information is obtained by associating the gradation value and the converted gradation value for each gradation value using the method described above. The gradation characteristic of the display unit 106 varies depending on a driving frequency, and therefore, the memory 102 stores correction information corresponding to a plurality of driving frequencies. FIG. 4A is a diagram schematically illustrating the correction information according to the first embodiment. In the first embodiment, the correction information includes one-dimensional look-up tables (LUTs) for different colors R, G, and B which associate gradation values (input gradation values) of R, G, and B of the pixels in the input image with converted gradation values.

FIG. 4A is a diagram illustrating the correction information in the driving frequency of 60 Hz. In the correction information in the driving frequency of 60 Hz, input gradation values of R, G, and B are associated with converted gradation values of R, G, and B so that the input image is displayed in the desired gradation characteristic in the display unit 106 driven by the driving frequency of 60 Hz. FIG. 4B is a diagram illustrating correction information in a. driving frequency of 48 Hz. In the correction information in the driving frequency of 48 Hz, input gradation values of R, G, and B are associated with converted gradation values of R, G, and B so that the input image is displayed in the desired gradation characteristic in the display unit 106 driven by the driving frequency of 48 Hz. The memory 102 stores the correction information corresponding to a frame rate of 60 Hz and correction information corresponding to a frame rate of 48 Hz.

The correction information is not limited to the one-dimensional LUTs for each of the colors described above. The correction information may be described in three-dimensional LUTs or may be information indicating the association between the input gradation values and the converted gradation values, such as coefficients and conversion formulae.

The gradation conversion unit 115 converts the gradation values of the pixels of the input image using correction information corresponding to a frame rate of the obtained input image so as to generate a display image. Since the display unit 106 is driven using the frame rate of the input image as a driving frequency, the gradation conversion unit 115 is seen to generate a display image using the correction information corresponding to the driving frequency of the display unit 106. The gradation conversion unit 115 outputs the display image to the display controller 116.

The display controller 116 outputs the driving frequency obtained from the driving frequency determination unit 113 and the display image obtained from the gradation conversion unit 115 to the display unit 106 and controls the display unit 106.

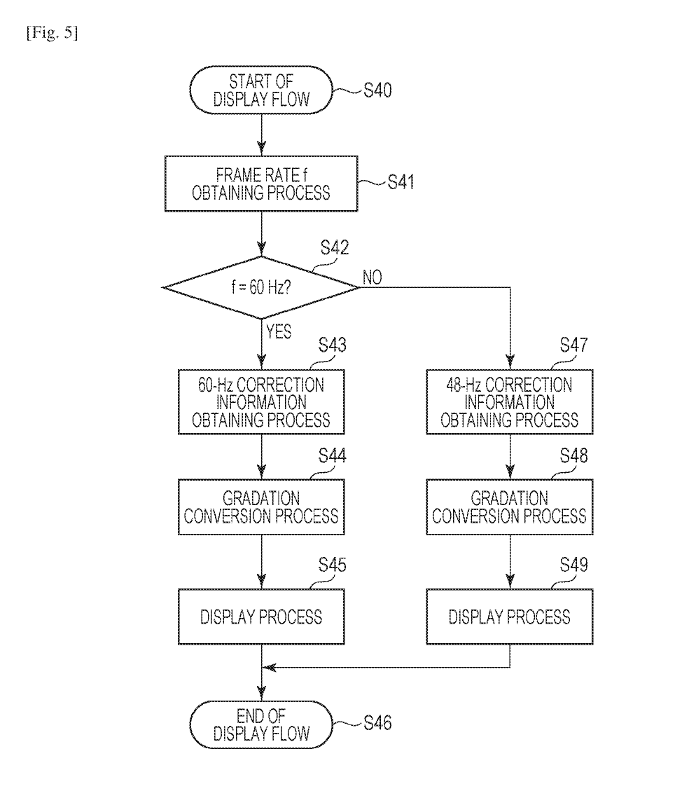

FIG. 5 is a flowchart of a display flow of the display apparatus 100 according to the first embodiment. Processes performed in the flow below are executed by the processor 101 in accordance with programs read from the memory 102. It is assumed that a frame rate of the input image is 60 Hz or 48 Hz in the first embodiment.

When an input image is input to the input unit 111, the display flow is started (S40). The frame rate obtaining unit 112 obtains a frame rate f of the input image (S41). The frame rate f is supplied to the driving frequency determination unit 113 and the correction information obtaining unit 114.

The correction information obtaining unit 114 determines whether the frame rate f is 60 Hz (S42). When the frame rate f is 60 Hz (Yes in step S42), the correction information obtaining unit 114 obtains the correction information corresponding to the driving frequency of 60 Hz from the memory 102 (S43). The gradation conversion unit 115 converts gradation values of the input image using the correction information corresponding to the driving frequency of 60 Hz output from the correction information obtaining unit 114 so as to generate a display image (S44). The gradation conversion unit 115 outputs the display image to the display controller 116.

The driving frequency determination unit 113 determines the obtained frame rate f (60 Hz) as a driving frequency to be output to the display controller 116. The display controller 116 controls transmittances of the liquid crystal elements of the display unit 106 in accordance with the display image and displays the image in the obtained driving frequency (S45).

When the frame rate f is not 60 Hz (No in step S42), the correction information obtaining unit 114 obtains the correction information corresponding to the driving frequency of 48 Hz from the memory 102 (S47). The gradation conversion unit 115 converts gradation values of the input image using the correction information corresponding to the driving frequency of 48 Hz output from the correction information obtaining unit 114 so as to generate a display image (S48). The gradation conversion unit 115 outputs the display image to the display controller 116.

The driving frequency determination unit 113 determines the obtained frame rate f (48 Hz) as a driving frequency to be output to the display controller 116. The display controller 116 controls transmittances of the liquid crystal elements of the display unit 106 based on the display image in the obtained driving frequency (S49).

As described above, the display apparatus 100 of the first embodiment includes the memory 102 which stores the correction information corresponding to the frame rate of 60 Hz and the correction information corresponding to the frame information of 48 Hz. The gradation conversion unit 115 generates a display image by converting the gradation values of the input image in accordance with the frame rate of the input image obtained by the frame rate obtaining unit 112 so that the input image is displayed in the desired gradation characteristic. Then the display controller 116 controls the display unit 106 such that the display unit 106 displays the image in the driving frequency corresponding to the frame rate of the input image based on the display image. Accordingly, the image may be displayed while a change of the gradation characteristic caused by a change of the driving frequency is suppressed.

Note that, in a case where correction information of a driving frequency corresponding to the frame rate of the input image is not stored in the memory 102, the display apparatus 100 may convert the input image into a display image using a method described below. In a case where the frame rate of the input image is 50 Hz, the correction information obtaining unit 114 obtains the correction information in the driving frequency of 60 Hz and the correction information in the driving frequency of 48 Hz from the memory 102. The correction information obtaining unit 114 generates correction information corresponding to the driving frequency of 50 Hz using the correction information in the driving frequency of 60 Hz and the correction information in the driving frequency of 48 Hz.

In the correction information of the driving frequency of 60 Hz, a gradation value obtained by performing the conversion on a gradation value i is represented by “60 TBL[i]”. Furthermore, in the correction information of the driving frequency of 48 a gradation value obtained by performing the conversion on the gradation value i is represented by “48 TBL[i]”. In the first embodiment, the gradation characteristic of the display unit 106 linearly changes relative to the driving frequency due to a change of the driving frequency. Here, a gradation value 50 TBL[i] after the conversion performed on the gradation value i in the driving frequency of 50 Hz may be obtained in accordance with Expression 1 below.

$$[ Math . 1 ]$$

$$50 TBL [ i ] = ( \frac{60 TBL [ i ] - 48 TBL [ i ]}{60 - 48} ) \times ( 50 - 48 ) + 48 TBL [ i ] \qquad Expression 1$$

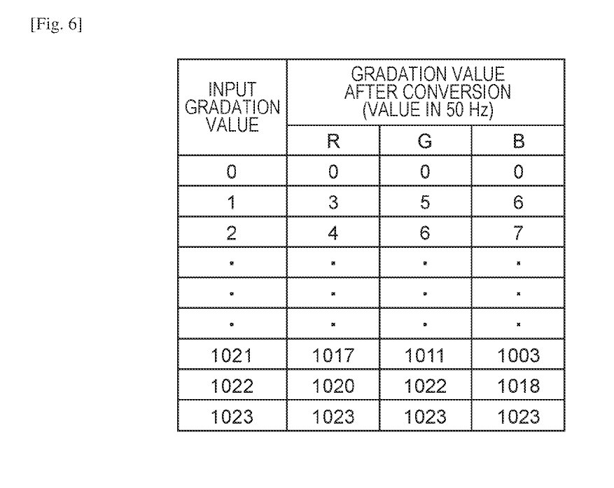

The correction information obtaining unit 114 generates correction information corresponding to the driving frequency of 50 Hz using the gradation value i obtained by Expression 1 and the converted gradation value 50 TBL[i]. FIG. 6 is a diagram illustrating the correction information in the driving frequency of 50 Hz obtained by Expression 1. The correction information obtaining unit 114 outputs the generated correction information in the driving frequency 50 Hz to the gradation conversion unit 115. The gradation conversion unit 115 generates a display image by converting the gradation value of the input image using the correction information in the driving frequency of 50 Hz.

Note that the correction information obtaining unit 114 may output the correction information in the driving frequency of 60 Hz and the correction information in the driving frequency of 48 Hz to the gradation conversion unit 115, and the gradation conversion unit 115 may generate a display image by employing Expression 1 to the gradation values of the pixels of the input image.

Note that in a case where the change of the gradation characteristic of the display unit 106 relative to the driving frequency may be represented by a function other than the linear relationship described above, correction information may be newly generated using the function.

### Second Embodiment

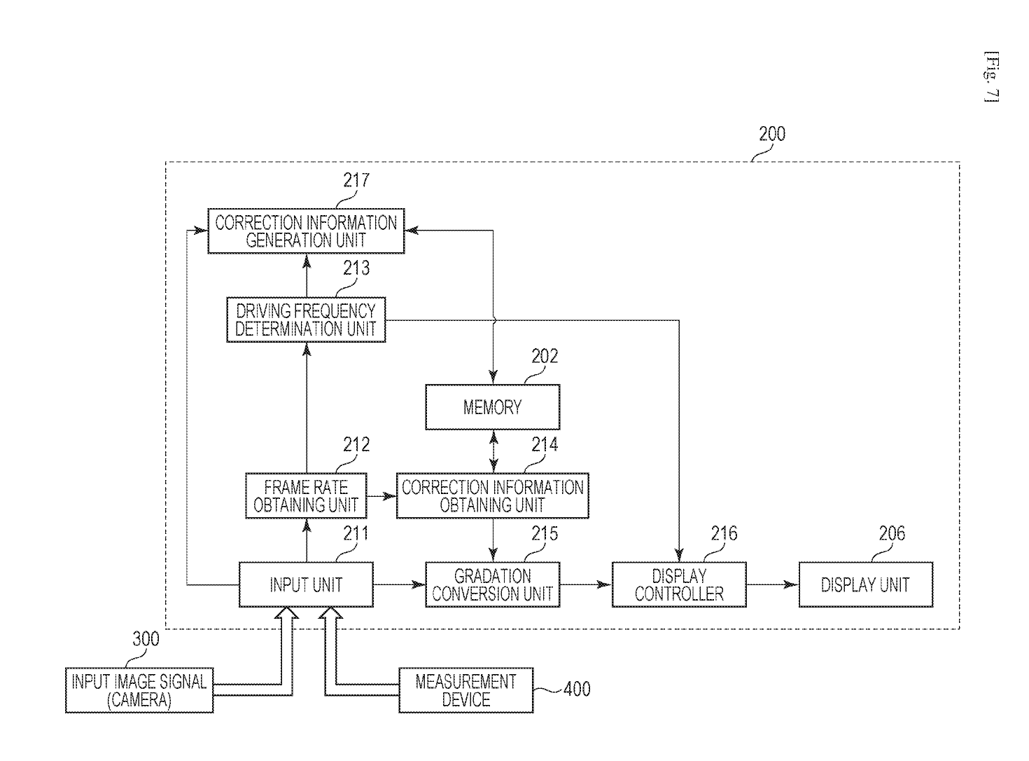

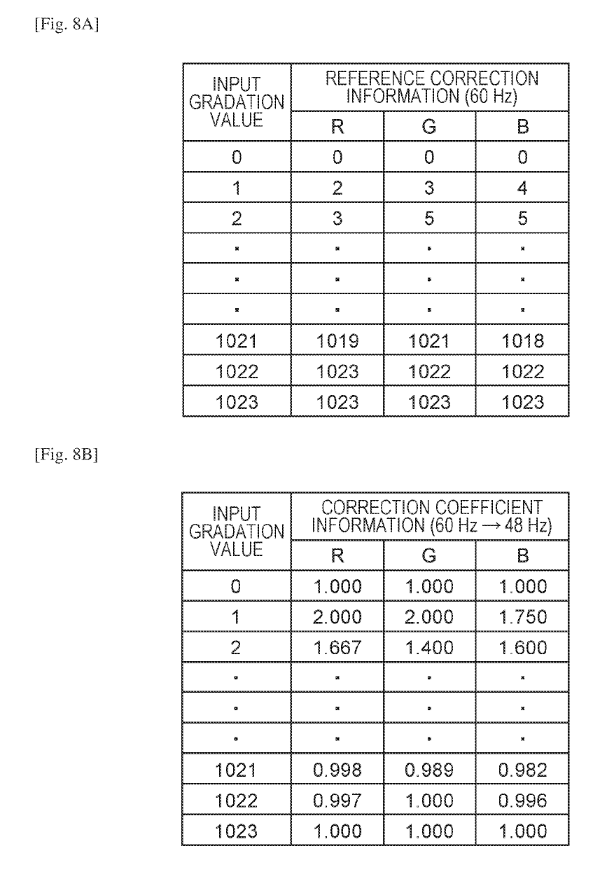

A configuration of a display apparatus 200 according to a second embodiment is the same as that of the display apparatus 100 according to the first embodiment, and therefore, a description thereof is omitted. FIG. 7 is a block diagram illustrating functional blocks of the display apparatus 200 according to the second embodiment, Among the functional blocks of the display apparatus 200 according to the second embodiment, a frame rate obtaining unit 212, a driving frequency determination unit 213, and a display controller 216 are the same as the frame rate obtaining unit 112, the driving frequency determination unit 113, and the display controller 116 according to the first embodiment, respectively, and therefore, descriptions thereof are omitted. A memory 202 stores reference correction information corresponding to a driving frequency of 60 Hz and correction coefficient information corresponding to a driving frequency of 48 Hz while setting the driving frequency of 60 Hz as a reference driving frequency. FIGS. 8A and 8B are diagrams illustrating the reference correction information and the correction coefficient information stored in the storage unit 202, respectively. FIG. 8A is a diagram illustrating the reference correction information stored in the storage unit 202. The reference correction information is similar to the correction information in the driving frequency of 60 Hz in the first embodiment. FIG. 8B is a diagram illustrating the correction coefficient information corresponding to the driving frequency of 48 Hz. The correction coefficient information indicates a rate of the correction information in the driving frequency of 48 Hz to the correction information (the reference correction information) in the driving frequency of 60 Hz. In other words, a value obtained by multiplying the reference correction information by the correction coefficient information is the correction information in the driving frequency of 48 Hz for each input gradation value.

A correction information obtaining unit 214 obtains the reference correction information or the reference correction information and the correction coefficient information from the memory 202 in accordance with a frame rate of an input image obtained from the frame rate obtaining unit 212. In a case where the frame rate of the input image is 60 Hz, the correction information obtaining unit 214 obtains the reference correction information from the memory 202 and outputs the reference correction information to a gradation conversion unit 215. The gradation conversion unit 215 converts gradation values of the input image using the reference correction information so as to generate a display image to be output to the display unit 206.

Furthermore, in a case where the frame rate of the input image is 48 Hz, the gradation conversion unit 215 obtains the reference correction information and the correction information corresponding to the driving frequency of 48 Hz from the memory 202. The correction information obtaining unit 214 multiplies the reference correction information by the correction coefficient information corresponding to the driving frequency of 48 Hz so as to calculate correction information of the driving frequency of 48 Hz to be output to the gradation conversion unit 215. The gradation conversion unit 215 converts the gradation values of the input image using the obtained correction information so as to generate a display image to be output to the display controller 216. The display controller 216 displays an image in the display unit 206 based on the obtained display image in the driving frequency determined by the driving frequency determination unit 213.

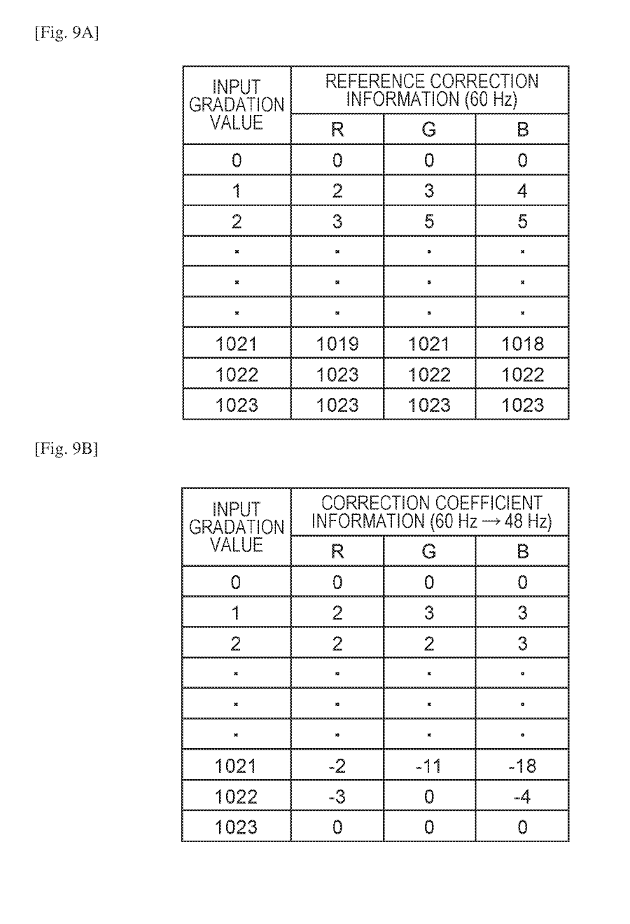

Note that the correction coefficient information is not limited to information on a rate of correction information in a driving frequency other than a reference driving frequency to reference correction information. The correction coefficient information may indicate a difference between correction information in a driving frequency other than a reference driving frequency and reference correction information. FIGS. 9A and 9B are diagrams illustrating the correction information corresponding to the driving frequency of 60 Hz (reference correction information in FIG. 9A) and correction coefficient information corresponding to the driving frequency of 48 Hz (FIG. 9B). In this case, a value obtained by adding the reference correction information to the correction coefficient information corresponding to the driving frequency of 48 Hz serves the correction information in the driving frequency of 48 Hz. A correction information generation unit 217 obtains a gradation characteristic of the display unit 206 in accordance with gradation values of a display image and a result of measurement of luminance or chromaticity of the display unit 206 displaying the display image. The correction information generation unit 217 generates reference correction information using the gradation characteristic of the display unit 206 and a desired gradation characteristic. The method for generating reference correction information according to the first embodiment is also used in the second embodiment.

The correction information generation unit 217 obtains the result of measurement of luminance or chromaticity of the display unit 206 displaying the display image from a measurement device 400 connected to the display apparatus 200 through an input unit 211. The measurement device 400 is a luminance measurement device or a chromaticity measurement device.

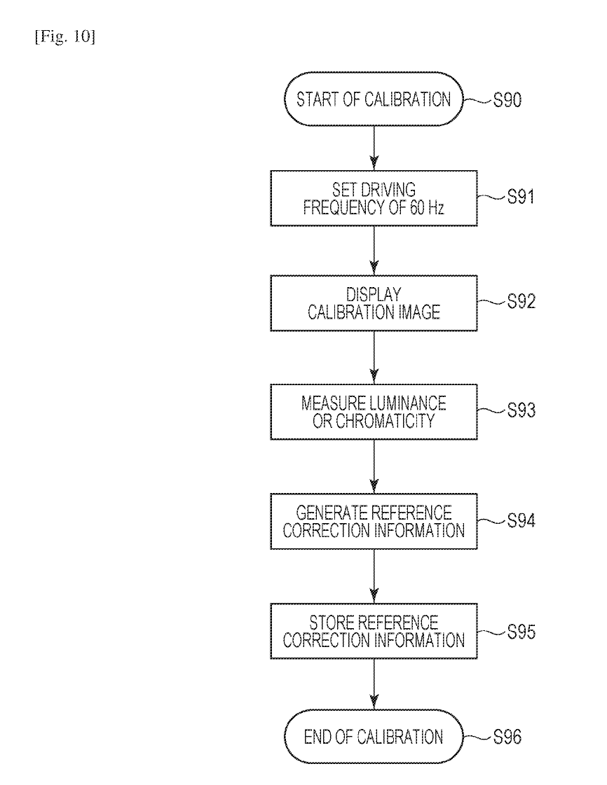

In the second embodiment, a method for obtaining reference correction information by calibration will be described. FIG. 10 is a flowchart illustrating a flow of calibration according to the second embodiment.

When calibration is started (S90), the driving frequency determination unit 213 outputs a driving frequency in 60 Hz serving as a reference to the display controller 216 irrespective of a frame rate of an input image (S91). The display controller 216 drives the display unit 206 in the driving frequency of 60 Hz so as to display an image for calibration (S92). The calibration image is generated so that luminance or chromaticity may be measured for individual gradation values. As the calibration image, a plurality of patches corresponding to a plurality of gradation values may be displayed in the same screen or the plurality of patches may be temporally displayed in a switching manner. When the calibration is started, the gradation conversion unit 215 does not perform a gradation conversion process on the calibration image.

The measurement device 400 measures luminance or chromaticity of the calibration image displayed in the display unit 206 and outputs a result of the measurement to the input unit 211 (S93). The input unit 211 outputs the obtained measurement result to the correction information generation unit 217. The correction information generation unit 217 obtains a gradation characteristic of the display unit 206 in the driving frequency of 60 Hz using the driving frequency (60 Hz) determined by the driving frequency determination unit 213 and the measurement result. The correction information generation unit 217 generates reference correction information using the gradation characteristic of the display unit 206 in the driving frequency of 60 Hz and the desired gradation characteristic (S94).

The correction information generation unit 217 outputs the generated reference correction information to the memory 202. The memory 202 stores the reference correction information (S95). In a case where the memory 202 has stored the reference correction information before the start of the calibration, the memory 202 updates the reference correction information. The calibration is thus terminated (S96).

Note that a driving frequency of the display unit 206 when the calibration is performed may not be the reference driving frequency described above. In a case where a calibration image is displayed in the display unit 206 in the driving frequency of 48 Hz, the correction information generation unit 217 obtains a gradation characteristic of the display unit 206 in the driving frequency of 48 Hz. The correction information generation unit 217 generates correction information corresponding to the driving frequency of 48 Hz using a gradation characteristic of the display unit 206 in the driving frequency of 48 Hz and the desired gradation characteristic.

The correction information generation unit 217 obtains correction coefficient information corresponding to the driving frequency of 48 Hz from the memory 202. The correction information generation unit 217 calculates reference correction information using the generated correction information in the driving frequency of 48 Hz and the correction coefficient information corresponding to the driving frequency of 48 Hz. The correction information generation unit 217 outputs the calculated reference correction information to the memory 202.

According to the display apparatus 200 described above, the memory 202 stores the reference correction information corresponding to the reference driving frequency selected from among a plurality of driving frequencies and the correction coefficient information for generating correction information in a driving frequency other than the reference driving frequency in combination with the reference correction information. By combining the reference correction information and the correction coefficient information, a display image may be generated such that the input image is displayed in the desired gradation characteristic in each of the plurality of driving frequencies. Accordingly, a change of the gradation characteristic caused by a change of the driving frequency may be suppressed.

Furthermore, since the relationship among correction information of the plurality of driving frequencies are stored as the correction coefficient information, the correction information of each of the plurality of driving frequencies may be obtained by performing calibration on one of the driving frequencies. Accordingly, a load of the calibration is reduced.

### Other Embodiments

Although the case where a frame rate of an input image and a driving frequency corresponding to correction information stored in a memory are 60 Hz or 48 Hz is illustrated in the first and second embodiments, the present invention is not limited to 60 Hz and 48 Hz. Other values, such as 100 Hz or 120 Hz, may be employed, and correction information or correction coefficient information for two or more frequencies may be stored.

Furthermore, although an input image is converted using correction information corresponding to a frame rate of an input image while a display unit is driven using the frame rate of the input image as a driving frequency of the display unit, the method for selecting correction information is not limited to this. A gradation correction unit may obtain correction information in accordance with a driving frequency set in a display apparatus and convert gradation values of an input image so as to generate a display image. In this case, the display apparatus includes a setting unit which sets the driving frequency of the display apparatus. The setting unit sets a driving frequency input by the user. The setting unit may set a driving frequency by selecting one of driving frequencies determined in advance depending on viewing environment or the like.

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-170595, filed Aug. 31, 2015, which is hereby incorporated by reference herein in its entirety.

1. A display apparatus comprising:
a display unit configured to display an image based on a display image;
a conversion unit configured to generate the display image by converting gradation values of an input image using reference correction information in a case where a frame rate of the input image is a first frame rate and generate the display image by converting the gradation values of the input image using the reference correction information and correction coefficient information in a case where the frame rate of the input image is a second frame rate which is different from the first frame rate; and
a controller configured to control the display unit so that the image based on the display image is displayed in a driving frequency corresponding to the frame rate of the input image.

2. The display apparatus according to claim 1, wherein the conversion unit generates the display image by converting the gradation values of the input image using values obtained by multiplying the reference correction information by the correction coefficient information in a case where the frame rate of the input image is the second frame rate.

3. The display apparatus according to claim 1, wherein the conversion unit generates the display image by converting the gradation values of the input image using values obtained by adding the reference correction information to the correction coefficient information in a case where the frame rate of the input image is the second frame rate.

4. The display apparatus according to claim 1, further comprising a correction information generation unit configured to obtain a result of measurement of luminance or chromaticity from a measurement apparatus which measures luminance or chromaticity of an image displayed in the display unit and generate the reference correction information in accordance with the result of the measurement of the luminance or the chromaticity of a calibration image displayed in the display unit in a driving frequency corresponding to the first frame rate.

5. The display apparatus according to claim 4, further comprising a determination unit configured to determine the driving frequency of the display unit so that the calibration image is displayed in the first frame rate in a case where calibration is started.

6. The display apparatus according to claim 1, further comprising a correction information generation unit configured to obtain a result of measurement of luminance or chromaticity from a measurement apparatus which measures luminance or chromaticity of an image displayed in the display unit and generate the reference correction information in accordance with the correction coefficient information and correction information generated using the result of the measurement of the luminance or the chromaticity of a calibration image displayed in a driving frequency corresponding to the second frame rate.

7. The display apparatus according to claim 1, further comprising a storage unit configured to store the reference correction information and the correction coefficient information.

8. The display apparatus according to claim 1,
wherein the display unit displays an image using a plurality of colors in accordance with the display image, and
wherein the reference correction information and the correction coefficient information have coefficients used to convert the gradation values of the input image into gradation values of the display image for each of the plurality of colors.

9. A display apparatus comprising:
a display unit configured to display an image based on a display image;
a determination unit configured to determine a driving frequency of the display unit;
a conversion unit configured to generate the display image by converting gradation values of an input image using reference correction information in a case where the driving frequency is a first frequency and generate the display image by converting the gradation values of the input image using the reference correction information and correction coefficient information in a case where the driving frequency is a second frequency which is different from the first frequency; and
a controller configured to control the display unit so that the image based on the display image is displayed in the driving frequency.

10. A method for controlling a display apparatus including a display unit which displays an image based on a display image, the method comprising:
generating the display image by converting gradation values of an input image using reference correction information in a case where a frame rate of the input image is a first frame rate and generating the display image by converting the gradation values of the input image using the reference correction information and correction coefficient information in a case where the frame rate of the input image is a second frame rate which is different from the first frame rate; and
controlling the display unit so that the image based on the display image is displayed in a driving frequency corresponding to the frame rate of the input image.

11. The method for controlling a display apparatus according to claim 10,
wherein the generating generates the display image by converting the gradation values of the input image using values obtained by multiplying the reference correction information by the correction coefficient information in a case where the frame rate of the input image is the second frame rate.

12. The method for controlling a display apparatus according to claim 10,
wherein the generating generates the display image by converting the gradation values of the input image using values obtained by adding the reference correction information to the correction coefficient information in a case where the frame rate of the input image is the second frame rate.

13. The method for controlling a display apparatus according to claim 10, further comprising obtaining a result of measurement of luminance or chromaticity from a measurement apparatus which measures luminance or chromaticity of an image displayed in the display unit and generating the reference correction information in accordance with the result of the measurement of the luminance or the chromaticity of a calibration image displayed in the display unit in a driving frequency corresponding to the first frame rate.

14. The method for controlling a display apparatus according to claim 13, further comprising determining the driving frequency of the display unit so that the calibration image is displayed in the first frame rate in a case where calibration is started.

15. The method for controlling a display apparatus according to claim 10, further comprising obtaining a result of measurement of luminance or chromaticity from a measurement apparatus which measures luminance or chromaticity of an image displayed in the display unit and generating the reference correction information in accordance with the correction coefficient information and correction information generated using the result of the measurement of the luminance or the chromaticity of a calibration image displayed in a driving frequency corresponding to the second frame rate.

16. The method for controlling a display apparatus according to claim 10, further comprising storing the reference correction information and the correction coefficient information.

17. The method for controlling a display apparatus according to claim 10,
wherein the display unit displays an image using a plurality of colors in accordance with the display image, and
wherein the reference correction information and the correction coefficient information have coefficients used to convert the gradation values of the input image into gradation values of the display image for each of the plurality of colors.

18. A method for controlling a display apparatus including a display unit which displays an image based on a display image, the method comprising:
determining a driving frequency of the display unit;
generating the display image by converting gradation values of an input image using reference correction information in a case where the driving frequency is a first frequency and generating the display image by converting the gradation values of the input image using the reference correction information and correction coefficient information in a case where the driving frequency is a second frequency which is different from the first frequency; and
controlling the display unit so that an image based on the display image is displayed in the driving frequency.

19. A program executable by a processor which controls a display apparatus in accordance with the method for controlling the display apparatus set forth in claim 10.

20. A program executable by a processor which controls a display apparatus in accordance with the method for controlling the display apparatus set forth in claim 18.

21. A processor readable storage medium which stores the program set forth in claim 19.

22. A processor readable storage medium which stores the program set forth in claim 20.
